(19) United States
(12) Patent Application Publication
(10) Pub. No.: US 2002/0100056 A1
(43) Pub. Date: Jul. 25, 2002

(54) Distributed broadband cable modem termination system

(76) Inventors: Edward J. Bortolini, Nederland, CO (US); Chia Chang Li, Holmdel, NJ (US); Roger W. Loots, Broomfield, CO (US)

Correspondence Address: PATTON BOGGS, PO BOX 270930, LOUISVILLE, CO, 80027, US

(21) Appl. No.: 09/766,736

(22) Filed: Jan. 22, 2001

(51) Int. Cl. H04N 7/173

(52) U.S. Cl. 725/111; 725/119; 725/121

(57) ABSTRACT

The distributed broadband cable modem termination system centralizes the point to multi-point function of the downstream signaling while simultaneously localizing the multi-point to single point functions of the upstream signaling. The upstream broadband cable termination segment of the broadband cable modem termination system is located at a different layer of the broadband cable network from the downstream broadband cable modem termination segment of the broadband cable modem termination system. By splitting the broadband cable modem termination system functions into separable and independently operable upstream and downstream functions, network deployment is optimized for a number of reasons. The downstream and upstream functions scale independently so the system can selectively add capacity where needed in the direction needed independent of the capacity in the reverse direction. In addition, this architecture provides additional flexibility by supporting a number of concurrently operational implementations. Within a single broadband cable network, the upstream and downstream segments of the broadband cable modem termination system can be located at different layers of the broadband cable network as long as the interconnected upstream and downstream segments of the broadband cable modem termination system for a particular communication path are at different levels of the broadband cable network.

### FIELD OF THE INVENTION

This invention relates to broadband cable network architectures and in particular to a distributed broadband cable modem termination system that centralizes the point to multi-point function of the downstream signaling while simultaneously localizing the multi-point to single point functions of the upstream signaling.

### PROBLEM

It is a problem in the field of broadband cable networks that the cable modem termination systems are centrally located in the cable head-ends or in the primary hubs that are connected to the cable head-ends. The original broadband cable transmission systems were engineered to provide a one-way distribution of video program material to the end user locations, therefore 95% of the available data transmission bandwidth in these broadband cable networks are dedicated to transmissions from the head-end to the end user locations. The upstream path of the broadband cable network is therefore a critical resource which limits the number of end user locations that can be served by a particular cable modem termination system and also limits the number and nature of new interactive services that can be offered to the end user locations. Therefore, existing service offerings are limited to those which place a minimal demand on the upstream communication capabilities of the broadband cable network. In addition, service providers have limited the number of end user locations that can be served by each passive fiber node in the broadband cable network to enable the upstream channel to serve these end user locations. Therefore, the bandwidth limitation of the upstream channel in the broadband cable network represents a service offering limitation and an inefficiency in terms of the number of end user locations that can be served.

### SOLUTION

The above described problems are solved and a technical advance achieved by the present distributed broadband cable modem termination system which centralizes the point to multi-point function of the downstream signaling while simultaneously localizing the multi-point to single point functions of the upstream signaling. The upstream broadband cable termination segment of the broadband cable modem termination system is located at a different layer of the broadband cable network from the downstream broadband cable modem termination segment of the broadband cable modem termination system.

By splitting the broadband cable modem termination system functions into separable and independently operable upstream and downstream functions, network deployment is optimized for a number of reasons. The downstream and upstream functions scale independently so the system can selectively add capacity where needed in the direction needed independent of the capacity in the reverse direction. In addition, this architecture provides additional flexibility by supporting a number of concurrently operational implementations. Within a single broadband cable network, the upstream and downstream segments of the broadband cable modem termination system can be located at different layers of the broadband cable network as long as the interconnected upstream and downstream segments of the broadband cable modem termination system for a particular communication path are at different levels of the broadband cable network.

### BRIEF DESCRIPTION OF THE DRAWINGS

FIGS. 1 and 2 illustrate in block diagram form the architecture of a prior art broadband cable network having a cable modem termination system in the head end and in the passive fiber nodes, respectively;

FIGS. 3 and 4 illustrate in block diagram form the architecture of a broadband cable network having the present distributed broadband cable modem termination system;

FIG. 5 illustrates in block diagram form implementation details of the downstream segment of the present distributed broadband cable modem termination system; and

FIGS. 6 and 7 illustrate in block diagram form implementation details of the upstream segment of the present distributed broadband cable modem termination system and signal routing functionality used in conjunction with the upstream segment of the present distributed broadband cable modem termination system, respectively.

### DETAILED DESCRIPTION

Existing broadband cable networks comprise a multi-layer network which are used to distribute program materials, such as video, from program sources that are connected to a head end, through the various layers of the multi-layer network to the end user locations. A typical multi-layer network comprises a multiplicity of layers (typically two) interposed between the head-end and the nodes that serve a plurality of end user locations. The original broadband cable transmission systems were engineered to provide a one-way distribution of video program material to the end user locations, therefore 95% of the available data transmission bandwidth in these broadband cable networks are dedicated to transmissions from the head-end to the end user locations. The upstream path of the broadband cable network is therefore a critical resource which limits the number of end user locations that can be served by a particular cable modem termination system and also limits the number and nature of new interactive services that can be offered to the end user locations. Therefore, existing service offerings are limited to those which place a minimal demand on the upstream communication capabilities of the broadband cable network. In addition, service providers have limited the number of end user locations that can be served by each passive fiber node in the broadband cable network to enable the upstream channel to serve these end user locations. Therefore, the bandwidth limitation of the upstream channel in the broadband cable network represents a service offering limitation and an inefficiency in terms of the number of end user locations that can be served.

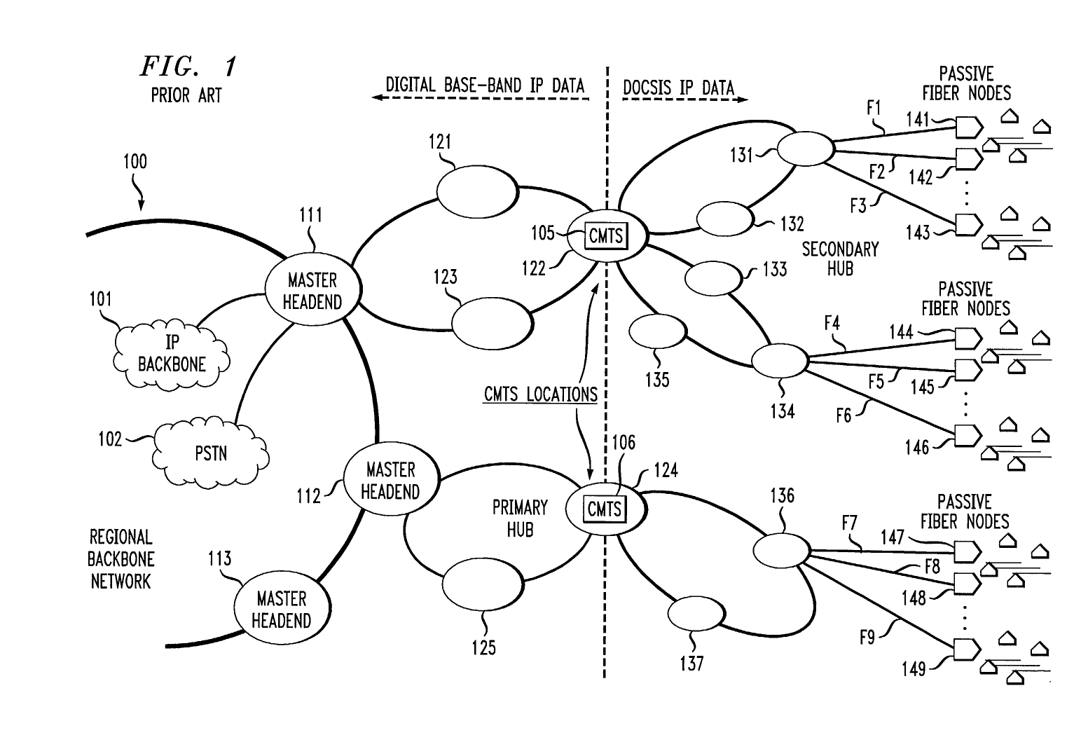

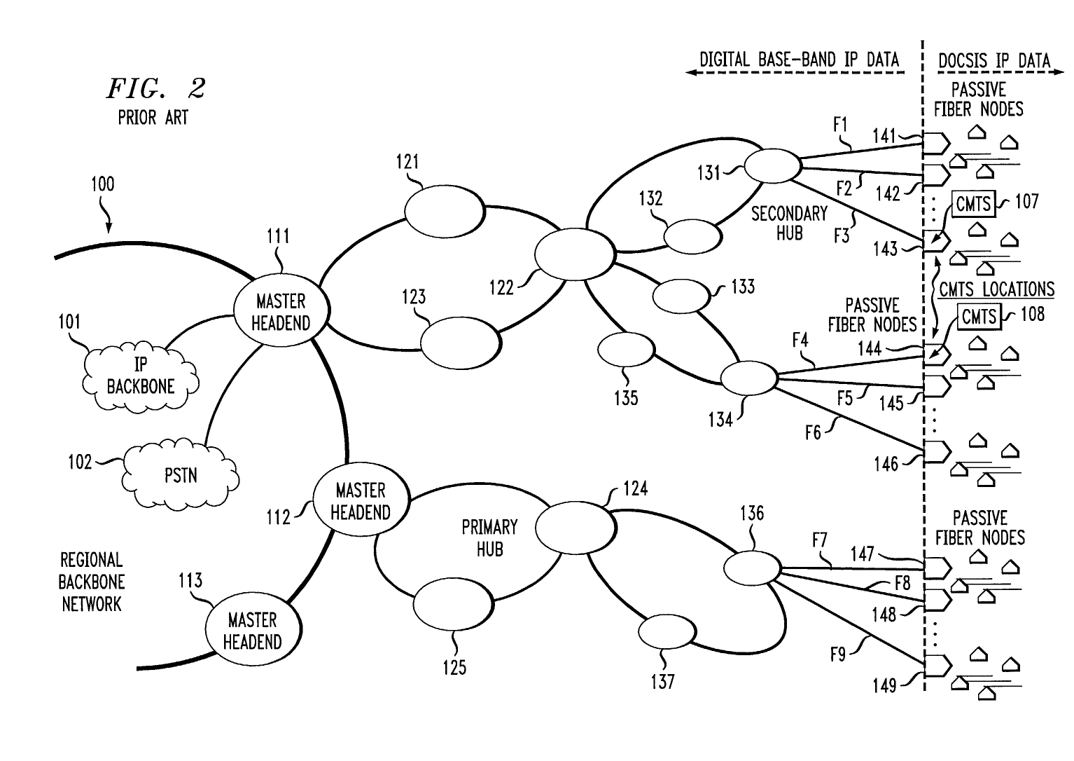

FIGS. 1 and 2 illustrate in block diagram form the architecture of a prior art broadband cable network having a cable modem termination system in the head-end and in the passive fiber nodes, respectively. In this network, the various end user locations are typically served by passive fiber nodes 141-149 which serve to interconnect a plurality of end user locations to a secondary hub 131-137 via corresponding fiber optic links F1-F9. A plurality of secondary hubs 131-137 are in turn interconnected to and served by primary hubs 121-125, a plurality of which are connected to a master head-end 111-113. The master head-end 111-113 receives data from various sources, of which an IP Backbone network 101 and the Public Switched Telephone Network (PSTN) 102 are shown. Thus, data transmitted via the IP Backbone 101 or the Public Switched Telephone Network 102 to the Master Head-end 111-113 is forwarded through the primary hubs 121-125 and the secondary hubs 131-137 to the passive fiber nodes 141-149 and the local loops to the end user locations. In the system as shown on FIG. 1, the data is in the form of digital base band IP transmissions from the source of the data (IP Backbone network 101 and the Public Switched Telephone Network 102) to the cable modem termination system 105, 106, where this data is converted to DOCSIS IP data for transmission to the end user locations. In the architecture of FIG. 1, the cable modem termination system 105, 106 is located in the primary hubs 121-125, while in the architecture of FIG. 2, the cable modem termination system 107, 108 is located in the passive fiber nodes 141-149. In the system of FIG. 1, the communication capability of the upstream DOCSIS channels (from the passive fiber nodes 141-149 to the cable modem termination system 105, 106) represents a communication bottleneck. The architecture of FIG. 2 solves the upstream DOCSIS channel communication bottleneck problem of the broadband cable network of FIG. 1, but at the cost of multiplying the number of cable modem termination systems 107, 108 required to provision the broadband cable network. The number of passive fiber nodes 141-149 is several orders of magnitude greater than the number of primary hub 121-125 locations. Therefore the cost of implementing the broadband cable network architecture of FIG. 2 is significantly greater than the cost of implementing the broadband cable network architecture of FIG. 1. The proliferation of cable modem termination systems 107, 108 also raises an issue of network reliability due to failure of one of a much greater number of equipment. In addition, the transmission of downstream Digital Base Band IP data on the existing Radio Frequency channels from the primary hubs 121-125 to the cable modem termination systems 107, 108 located in the passive fiber nodes 141-149 is very inefficient compared to the use of the existing DOCSIS Radio Frequency channels. Furthermore, the cost of replacing the existing DOCSIS Radio Frequency channels with links that can better support the downstream Digital Base Band IP data represents an additional and significant implementation cost.

Distributed Broadband Cable Modem Termination System Architecture

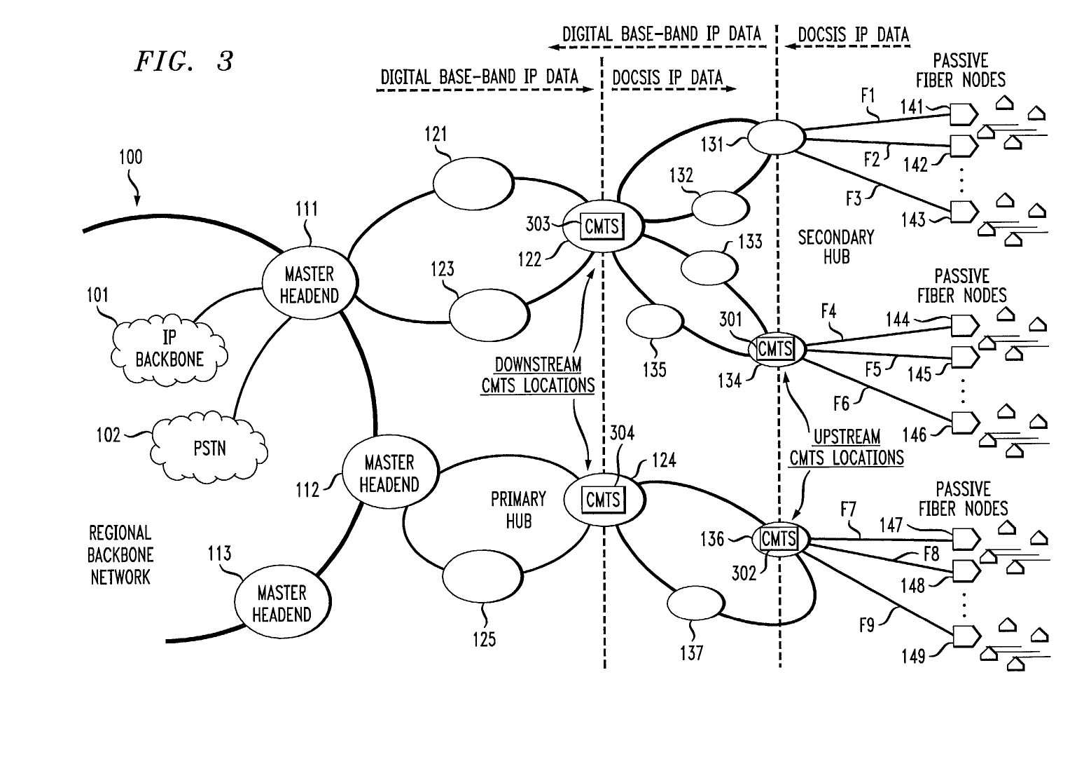

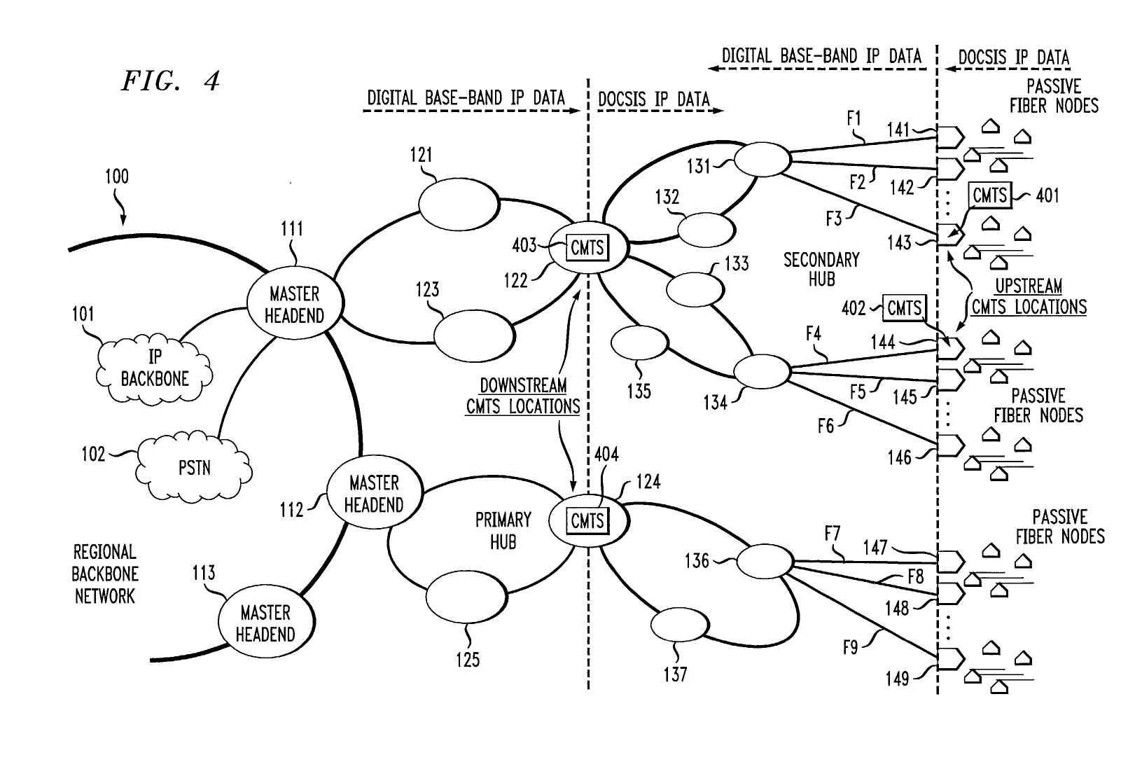

FIGS. 3 and 4 illustrate in block diagram form the architecture of a broadband cable network having the present distributed broadband cable modem termination system which centralizes the point to multi-point function of the downstream signaling while simultaneously localizing the multi-point to single point functions of the upstream signaling. The upstream broadband cable termination segments 301, 302 and 401, 402 of the broadband cable modem termination system of FIGS. 3 and 4, respectively, are located at a different layer of the broadband cable network from the downstream broadband cable modem termination segments 303, 304 and 403, 404 of the broadband cable modem termination system.

By splitting the broadband cable modem termination system functions into separable and independently operable upstream and downstream functions, network deployment is optimized for a number of reasons. The downstream and upstream functions scale independently so the system can be managed to selectively add capacity where needed in the direction needed independent of the capacity in the reverse direction. In addition, this architecture provides additional flexibility by supporting a number of concurrently operational implementations. Within a single broadband cable network, the upstream and downstream segments of the broadband cable modem termination system can be located at different layers of the broadband cable network as long as the interconnected upstream and downstream segments of the broadband cable modem termination system for a particular communication path are at different levels of the broadband cable network.

By having the upstream signaling in digital format and transmitted from the upstream segments 301, 302, 401, 402 of the distributed broadband cable modem termination system that are located closer to the end user locations, there is better upstream data transmission performance with a predictable dynamic range and greater transmission distances due to the more robust digital baseband transmission characteristics. There is also a simplified hub architecture since there is no longer a need to stack Radio Frequency signals in the hub to manage traffic, and an IP data concentrator is used to route the received signals. In addition, the data processing is concentrated in the head-end. The upstream routing is shared across the broadband cable network, with the IP network configuration being centralized along with the timing references. This also reduces the power requirements for the passive fiber nodes 141-149. The number of end user locations impacted by an upstream failure is reduced, since the upstream segments 301, 302, 401, 402 of the distributed broadband cable modem termination system are migrated to localized presence with fewer end user locations being served by each upstream segment 301, 302, 401, 402 of the distributed broadband cable modem termination system. In the case of locating the upstream segments 301, 302 in the secondary hubs 134, 136, respectively, there is an economy of having each upstream segment serve a plurality of passive fiber nodes. In the case of locating the upstream segments 401, 402 in the passive fiber nodes, 143, 144, respectively, there is a larger number of upstream segments required, but more effective bandwidth provided to the subscribers. FIG. 4 illustrates only two upstream segments 401, 402, for simplicity and there is an upstream segment located in each of the passive fiber nodes. In addition, there can be combinations of the implementations shown in FIGS. 3 and 4, where some secondary hubs are equipped with upstream segments 301, 302, while other secondary hubs are served by upstream segments 401, 402 located in the passive fiber nodes. Therefore, the practicalities of the installation environment can be addressed by using the one of these implementations that is most effective.

The downstream DOCSIS physical layer is optimized for the broadcast nature of the physical layer and can utilize the high bandwidth Radio Frequency channels that are co-located with the existing Radio Frequency video transmissions. Thus, the IP data is piggybacked with the downstream video data. The upstream DOCSIS physical layer encounters shorter delays and fewer endpoints per node which significantly reduces collisions between competing signals which reduces contention at the MAC layer of the signaling protocol. By the proper selection of the partition of the broadband cable modem termination system, all upstream DOCSIS channels are available on each coaxial segment. In addition, this architecture offers an opportunity to implement new chip set architectures. By placing the downstream cable modem termination system functions in a centralized network location and the upstream cable modem termination system functions in distributed locations near service endpoints, this optimizes the overall solution. This takes advantage of legacy RF transport in the downstream and multi-vendor digital IP transport in the upstream. The upstream bandwidth can be managed on a per passive fiber node basis.

Downstream and Upstream Implementation Details

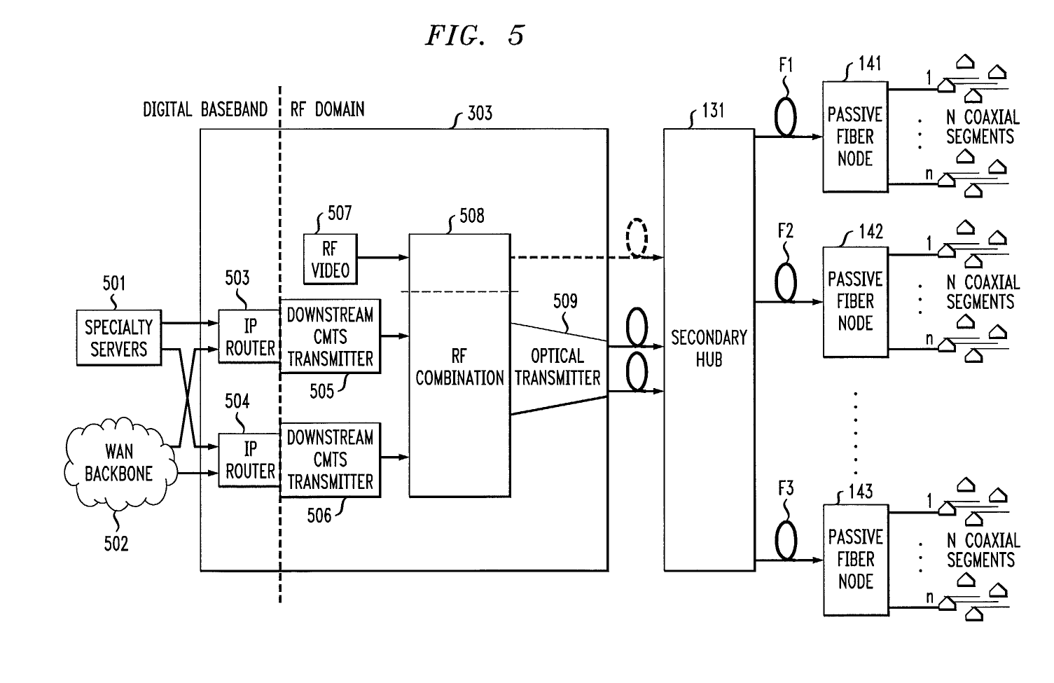

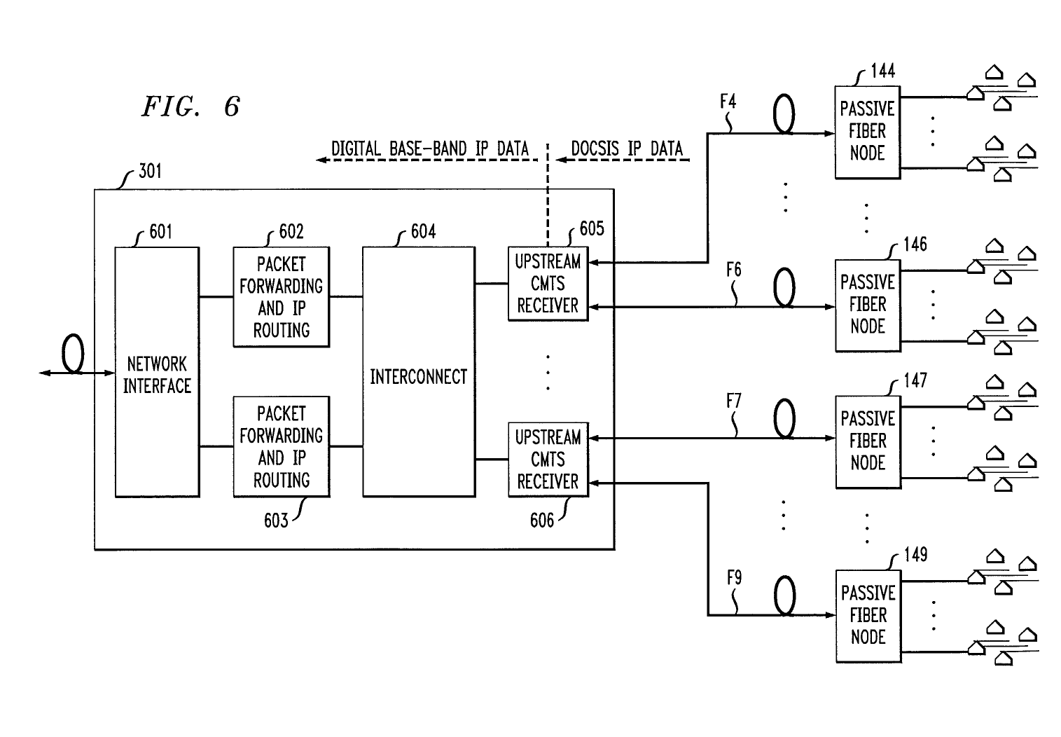

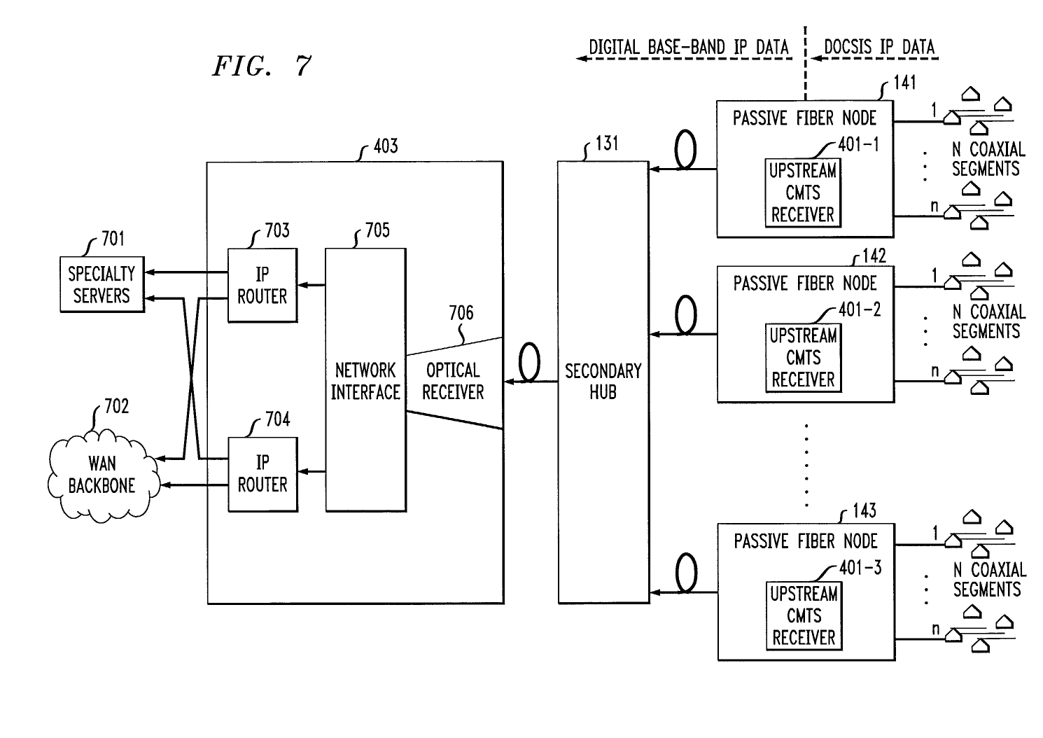

FIG. 5 illustrates in block diagram form typical implementation details of the downstream segment 303 of the present distributed broadband cable modem termination system while FIGS. 6 and 7 illustrate in block diagram form typical implementation details of the upstream segment 301 of the present distributed broadband cable modem termination system and signal routing functionality used in conjunction with the upstream segment of the present distributed broadband cable modem termination system, respectively.

The downstream segment 303 of the present distributed broadband cable modem termination system comprises circuitry that functions to convert the format of the Digital Baseband IP program materials that are received from specialty servers 501 and the Wide Area Network Backbone 502. These materials are received by one or more IP Routers 503, 504 for distribution to the end users. The IP Routers 503, 504 direct the received Digital Baseband IP program materials into a plurality of data streams that represent the cable broadcast channels. These cable broadcast channels are converted from the Digital Baseband IP data format into Radio Frequency format by the downstream CMTS transmitters 505, 506 and these signals are combined with the RF Video Carrier 507 by RF Combination circuit 508 to produce a combined signal transmission. This resultant radio frequency transmission is output by optical transmitter 509 on to the fiber optic (or other broadband) cables that serve to interconnect the downstream segment 303 of the present distributed broadband cable modem termination system with the next layer of the multi-layer broadband cable network, shown here as secondary hub 131. The secondary hub 131 serves to distribute the received signal transmission to the plurality of passive fiber nodes 141-143 via fiber optic cables F1-F3 for transmission to the end user locations in well known fashion. The passive fiber nodes 141-143 typically serve a plurality (n) of end user locations via coaxial segments that serve to connect the end user locations to the passive fiber nodes 141-143.

FIG. 6 illustrates an implementation of the upstream segment 301 of the present distributed broadband cable modem termination system as used in a network application, such as that shown in FIG. 3. The upstream segment 301 of the present distributed broadband cable modem termination system comprises a plurality of upstream CMTS receivers 605, 606 that serve to terminate the optical fiber cables F4-F9 from associated passive fiber nodes 144-149. The radio frequency signals received by the upstream CMTS receivers 605, 606 are converted to digital baseband IP data and forwarded through interconnect 604 to one or more packet forwarding and IP routers 602, 603 for delivery to network interface 601 and thence upstream to the cable head-end.

FIG. 7 illustrates additional details of the implementation of the upstream segment 401 (shown here as 401-1 to 401-3 to reflect the presence of an upstream segment in each of the passive fiber nodes 141-143 served by a secondary hub 131) of the present distributed broadband cable modem termination system as used in a network application, such as that shown in FIG. 4. The upstream segment 401 of the present distributed broadband cable modem termination system is implemented in the various passive fiber nodes 141-143 using the apparatus shown in FIG. 6. Upstream of this apparatus is the signal routing functionality 403, located in the head-end, used in conjunction with the upstream segment 401 of the present distributed broadband cable modem termination system and which comprises an optical receiver 706 connected to secondary hub 131 for receiving upstream signals transmitted by the upstream segment 401 of the present distributed broadband cable modem termination system that are located in the passive fiber nodes 141-143. The optical receiver 706 passes the received digital baseband IP data through network interface 705 to one or more IP routers 703, 704 which function to forward the received data to selected destinations in specialty servers 701 and via Wide Area Network Backbone 702.

Media Access Control Options

The allocation of bandwidth can be effected either at a central location or in a distributed manner. The bandwidth allocation can be implemented using a MAP transmitted downstream from the head-end to the downstream segment of the distributed broadband cable modem termination system. The passive fiber nodes transmit bandwidth requests upstream to the head-end while the head-end transmits utilization information to the passive fiber nodes. The degree to which the allocation is managed at the passive fiber nodes can be varied from centralized control to a significant amount of local control, where the decisions made at the passive fiber nodes are transmitted to the head-end.

Summary

The present distributed broadband cable modem termination system centralizes the point to multi-point function of the downstream signaling while simultaneously localizing the multi-point to single point functions of the upstream signaling to thereby eliminate the upstream channel signaling bottleneck of existing broadband cable networks.

What is claimed:

1. A broadband modem termination system for managing data transmissions through a broadband network that interconnects a plurality of end user locations and a head-end, said broadband network comprising a hierarchical network having at least two levels, said broadband modem termination system comprising:
downstream data transmission means, located at a first level of said hierarchical network, for transmitting data in a downstream direction from a source of program material at said head-end to selected ones of said plurality of end user locations; and
upstream data transmission means, located at a second level of said hierarchical network, for transmitting control data received from at least one of said plurality of end user locations in an upstream direction to said head-end, wherein said second level is located downstream of said first level in said hierarchical network.

2. The broadband modem termination system of claim 1 wherein said downstream data transmission means comprises:
means for converting data received in digital baseband IP format to data in a radio frequency based format for transmission to selected ones of said plurality of end user locations.

3. The broadband modem termination system of claim 2 wherein said upstream data transmission means comprises:
means for converting data received in a radio frequency based format to data in digital baseband IP format for transmission to said head-end.

4. The broadband modem termination system of claim 1 wherein said downstream data transmission means and said upstream data transmission means operate independent of each other.

5. The broadband modem termination system of claim 1 wherein said upstream data transmission means comprises:
means for converting data received in a radio frequency based format to data in digital baseband IP format for transmission to said head-end.

6. A method of operating a broadband modem termination system for managing data transmissions through a broadband network that interconnects a plurality of end user locations and a head-end, said broadband network comprising a hierarchical network having at least two levels, said broadband modem termination system comprising the steps of:
transmitting data from a downstream data transmission apparatus, located at a first level of said hierarchical network, in a downstream direction from a source of program material at said head-end to selected ones of said plurality of end user locations; and
transmitting control data from an upstream data transmission apparatus, located at a second level of said hierarchical network, and received from at least one of said plurality of end user locations in an upstream direction to said head-end, wherein said second level is located downstream of said first level in said hierarchical network.

7. The method of operating a broadband modem termination system of claim 6 wherein said step of transmitting data from a downstream data transmission apparatus comprises:
converting data received in digital baseband IP format to data in a radio frequency based format for transmission to selected ones of said plurality of end user locations.

8. The method of operating a broadband modem termination system of claim 7 wherein said step of transmitting control data from an upstream data transmission apparatus comprises:
converting data received in a radio frequency based format to data in digital baseband IP format for transmission to said head-end.

9. The method of operating a broadband modem termination system of claim 6 wherein said step of transmitting data from a downstream data transmission apparatus and said step of transmitting control data from an upstream data transmission apparatus operate independent of each other.

10. The method of operating a broadband modem termination system of claim 6 wherein said step of transmitting control data from an upstream data transmission apparatus comprises:
converting data received in a radio frequency based format to data in digital baseband IP format for transmission to said head-end.
